(19) United States
(12) Patent Application Publication
(10) Pub. No.: US 2025/0328729 A1
(43) Pub. Date: Oct. 23, 2025

(54) BIDIRECTIONAL PERSONAL FINANCIAL STORY CREATOR

(71) Applicant: WELLS FARGO BANK, N.A., San Francisco, CA (US)

(72) Inventors: Patti M. Miyakawa, Millbrae, CA (US); Sadie S. Salim, Mill Valley, CA (US); Dennis E. Montenegro, Concord, CA (US); Jennifer Toby Whateley, Fremont, CA (US)

(21) Appl. No.: 18/643,784

(22) Filed: Apr. 23, 2024

(51) Int. Cl. G06F 40/253; G06Q 40/06

(52) U.S. Cl. CPC G06F 40/253; G06Q 40/06

(57) ABSTRACT

The present disclosure generally relates to techniques for implementing a virtual assistant application using machine learning. The systems and methods can receive an input from a user. The input can be associated with a problem to be solved. Using a machine learning model, the systems and methods can determine a style and an intent of the user based on the input, determine extracted data that includes information corresponding to the style and intent, predict a desired result based on the extracted data, and generate a set of actions. The set of actions can be based in part on the style of the user and the intent of the user. Each action in the set of actions can correspond to a step that the user can take to accomplish the desired result. The systems and methods can output a signal associated with a representation of the set of actions.

### TECHNICAL FIELD

Embodiments of the present disclosure generally relate to chatbots, and more particularly to improved techniques for providing a virtual assistant application to give bi-directional storytelling style instructions.

### BACKGROUND

Organizations use automated chat platforms in the form of virtual assistants (e.g., chatbots) to engage in live conversations to facilitate customer service solutions. Organizations leverage these automated chat platforms to simulate live conversation to provide timely and responsive services to their customers as a cost-effective alternative to employing service people engaged in live communication. The use of automated chat platforms has become especially popular through the widespread use of the Internet as users migrate to the online space to satisfy their everyday needs (e.g., banking, shopping, communicating, traveling, etc.). Additionally, with the rise in machine learning and artificial intelligence technologies, virtual assistants are able to more closely and more intelligently emulate the context and style of live conversations, thereby enabling a more natural conversation and resulting in improved conversational experiences. In other words, the virtual assistants are able to understand the user's intention based on inputs (e.g., spoken, written, etc.) received from the user and respond accordingly.

Despite the progress made in the field of chatbots, there remains a need in the art for improved techniques for providing a virtual assistant application to give bi-directional storytelling style instructions.

### SUMMARY

Certain aspects and features of the present disclosure generally relate to chatbots. More specifically and without limitation, techniques disclosed herein relate to improved techniques for providing a virtual assistant application to give bi-directional storytelling style instructions. For example, a system for implementing a virtual assistant application using machine-learning is provided. The system includes one or more processors. The system also includes a memory coupled to the one or more processors. The memory includes instructions that when executed by the one or more processors, cause the one or more processors to receive an input from a user. The input can be associated with a problem to be solved. The instructions can further cause the one or more processors to use a machine learning model to determine a style and intent of the user based on the input, determine extracted data that includes information corresponding to the style and intent of the user, predict a desired result based on the extracted data, and generate a set of actions. The generated set of actions can be based in part on the style of the user and the intent of the user. Additionally, each of the set of actions can correspond to a step that the user can take to accomplish the desired result. The instructions can further cause the one or more processors to output a signal associated with a representation of the set of actions. In some examples, the problem to be solved can correspond to a financial goal of the user. In some examples, the style can be determined by one or more vocal characteristics of the audio input. According to one example, the input received can be an audio input.

Additionally, the instructions can further cause the one or more processors to detect a natural language corresponding to the audio input. The instructions can further cause the one or more processors to convert the audio input into a text data via a speech-to-text algorithm.

According to another example, the representation of the set of actions can include a graphical visualization component. The graphical visualization component can be in the form of a graph, a timeline, or any other form of visual component. The graphical visualization component can dynamically update based on at least one of the input, the determined intent, or the determined style. In some other examples, the representation of the set of actions can include an audio output.

According to yet another example, the instructions can further cause the one or more processors to receive a second input from the user. Additionally, the instructions can cause the one or more processors to adjust, using the machine learning model, the representation of the set of actions based on the second input.

Other examples include methods and computer programs recorded on one or more computer storage devices, where the methods and computer programs are each configured to perform the actions described above.

Numerous benefits are achieved by way of the various embodiments over conventional techniques. For examples, embodiments described herein provide for systems and methods for implementing a virtual assistant application using machine learning. The systems and methods described herein provide a virtual assistant application that can generate a virtual assistant that is customized by the user to provide an empathic, encouraging, and non-judgmental environment for the user to interact with. Additionally, the systems and methods described herein provide for a virtual assistant application that blends the arts of customer interviewing, financial therapy, and coaching via utilization of bi-directional and personable stories that the user can easily relate with since the responses from the virtual assistant application match the style and intent of the user.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example virtual assistant application environment, according to some aspects of the present disclosure;

FIG. 2 is a block diagram illustrating a computing system implementing a virtual assistant application, according to some aspects of the present disclosure;

FIG. 3 is a block diagram illustrating an example virtual assistant application environment, according to some aspects of the present disclosure;

FIG. 4 is a block diagram illustrating a distributed system for implementing a virtual assistant application, according to some aspects of the present disclosure;

FIG. 5 is a flowchart of an example of a process for implementing a virtual assistant application, according to some aspects of the present disclosure;

FIG. 6 is a block diagram illustrating an example computer-readable medium or computer-readable device including processor-executable instructions configured to embody one or more of the aspects set forth herein; and

FIG. 7 is a block diagram illustrating an example computing environment where one or more of the aspects set forth herein are implemented, according to some aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Embodiments of the present disclosure generally relate to chatbots, and more particularly to improved techniques for providing a virtual assistant application to give bi-directional storytelling style instructions. A chatbot is an electronic user interface that helps users accomplish a specific task. A chatbot utilizes natural language conversation to provide instructions for accomplishing the task to the user. When a user interacts with a chatbot, the chatbot evaluates the user input and determines the appropriate instructions to help the user. Chatbots may be fully automated in that they require little to no human intervention to function. In this way, an organization can deploy a chatbot over the internet as an additional feature of their online website, for example, to aid users with questions they may have. The use of chatbots eliminates the need to employ live service operators thereby providing a cost-effective solution to providing timely and responsive customer service to users.

Virtual assistant applications employing chatbots may use artificial intelligence and machine learning to discern more information about the user as it relates to the specific task. Chatbots using artificial intelligence and machine learning can closely tailor the instructions to the specific task that the user seeks to accomplish thereby resulting in more accurate and efficient customer service. Additionally, such chatbots can learn over time based on previous interactions with users in an automatic and efficient manner to improve its responses and accuracy. This reduces the need for manual training, updates, monitoring, or human intervention of the customer service experience. Furthermore, this increases computational efficiency, accessibility (e.g., a virtual assistant application can be widely deployed over the internet and accessible at any time), and understanding of complex problems. Virtual assistant applications utilizing artificial intelligence and machine learning also leads to improvements to the computational efficiencies of a device on which the virtual assistant application is located (e.g., a computer or a computing device) since the application is updated (e.g., learns) and is retained on an on-going basis; thus, the responses generated by the virtual assistant application are not stale or pre-programmed, but rather are dynamic and automatically updated based on learned events. This leads to an increase in the likelihood that users will interact with the smart virtual assistant, rather than another source of information (e.g., searching terms and explanations on the internet).

According to an example of the present disclosure, a system for implementing a virtual assistant application using machine learning is provided. The virtual assistant application is a computer program that can engage in conversations with users. The virtual assistant application can respond to natural language messages from the user (e.g., user inputs in the form of questions, concerns, anecdotes, etc.). The natural language messages can be in the form of audio inputs such as a user providing a spoken utterance to the user device which is interpreted by the virtual assistant application. In other examples, the natural language messages can be in the form of text inputs such as a user using a keyboard, smart phone, or other electronic device with a keyboard to type messages and communicate with the virtual assistant application. Example electronic devices that a user may use to communicate with the virtual assistant application may include mobile devices, desktop computers, portable computers, tablets, microphones, speakers, touchpads, keyboards, webcams, and the like.

Staying with the above-mentioned example, the virtual assistant application can utilize artificial intelligence and machine learning to evaluate user inputs for a style and intent and predict a desired result that the user seeks to accomplish. These techniques can further include generating an output for the user, where the output is a representation of a set of actions the user can take to accomplish the desired result. Additionally, the representation can be generated by the virtual assistant application such that it corresponds (e.g., matches) the determined style and intent of the user.

Continuing with the example, when the virtual assistant application receives a user input, the virtual assistant application can perform pre-processing operations on the inputs. The pre-processing operations can include determining a style, and in some examples, the style can be determined using a machine learning model. The style may be determined by an analysis of one or more characteristics of the user input. The characteristics analyzed by the virtual assistant application may include the vocabulary used by the user, the sentence complexity, a pre-determined education level of the user, a pre-determined age of the user, a formality characteristic of the user input, the context of the user input, the form of the input (e.g., anecdotal stories versus objective questioning), or a politeness level of the user input. The style can also include the pace of speaking, volume, intonations, cadence, rhythm, use of filler words, language, accent, inductive or deductive style, and the like. Once the machine-learning model discerns the style of the user, the output generated by the virtual assistant application (e.g., the representation) can be based on the style. In other words, the output may match the user's style thereby providing for a more natural and comfortable environment for the user to interact with the virtual assistant application.

The pre-processing operations can also include analyzing the inputs to determine an intent of the user. Similar to determining the style, in some examples, a machine learning model can be utilized to determine the intent. The determined intent allows the virtual assistant application to understand what the user's goal is (e.g., what user wants to accomplish or the problem to be solved). The intent may be determined from a single user input (e.g., a direct question of the user such as “what salary is needed to afford a home of this price?”) or in some examples, through compiling and analyzing a series of user inputs followed by follow-up questions provided by the virtual assistant application (e.g., inputs and responses exchanged during a conversation with the virtual assistant application).

After the user input is pre-processed, the virtual assistant application can determine extracted data from the user input, where the extracted data includes information about the determined style and the determined intent. The extracted data can be passed to a conversation manager module. In some examples, the input may be passed directly to the conversation manager module and not undergo the pre-processing operations described above. Passing an input directly to the conversation manger module may be advantageous where the input is so short (e.g., the user provides a response to a yes/no question) or there has been enough back and forth exchange between the user and the virtual assistant application that the virtual assistant application has a sufficient understanding of the user's style and intent. In this way, the computational efficiency of the virtual assistant application is improved because the application can determine to bypass the pre-processing module when it is not needed thus resulting in a reduction in processing.

The conversation manager module may utilize a second machine learning model to facilitate the conversation between the virtual assistant application and the user. In some examples, the same machine learning model used in the pre-processing module may be used in the conversation manager module. Once the extracted data is passed to the conversation manager module, a prediction engine may predict and generate the steps the user needs to take to satisfy the intent (e.g., the goal or problem to be solved). After the virtual assistant application determines the optimal steps (e.g., set of actions) to take to achieve the desired result, a representation engine can generate a representation (e.g., an output signal) of the set of actions. In some examples, the representation can include a graphical visualization component of the set of actions in the form of a timeline and the virtual assistant application can instruct the user, in conjunction with the timeline, what steps the user needs to take. In other examples, the representation can be a graphical visualization component in the form of a graph. In yet another example, the representation can be a text output in a “story” format (e.g., anecdotally) delivered from the second- or third-person perspective.

The representation can be received by a user device such as a mobile device, a table, a desktop computer, a personal laptop computer, and the like. The user device may have a display region for displaying the representation. Additionally, a virtual interface may be included in the display region, where the virtual interface includes the graphical visualization component generated by the representation engine (e.g., graphs, timelines, etc.). The display region can also include a digital representation of the virtual assistant (e.g., an avatar) and a series of dialogue boxes corresponding to the sequence progression of the conversation between the user and the virtual assistant application. In this way, a user will feel they are communicating directly with the avatar.

Focusing now on the digital representation of the virtual assistant, the avatar that is displayed in the display region can be fully customizable (e.g., designed completely by the user) or pre-selected from a list of pre-generated options. In some examples, the pre-configured list may include a list of avatars that represent humans, celebrities, animals, inanimate objects, or any combination.

Additionally, the avatar may be generated based on the various data associated with the inputs such that an avatar is generated that models the knowledge, experience, look, behavior, mannerisms, beliefs, opinions, and appearance of the user who interacting with it. Additionally, or alternatively, the user can set preferences on the appearance of the avatar to emulate a third person (e.g., mother, father, brother, sister, relative, celebrity, or random person). Moreover, the virtual assistant can adapt over time through its interaction with the user to more accurately represent the user as the user changes over time. This can include the avatar gaining new knowledge, changing in appearance as the user grows older, etc. In this way, the virtual assistant implemented by the virtual assistant application can be aware of who the user is and form personal relationship with the user through the usage of bi-directional and personal interactions. These features of the avatar enable the avatar to be relatable to the user.

Continuing on with the digital representation of the virtual assistant, the selection or generation of the avatar can be conceptually represented in three varying levels of complexity. The first level of complexity may be a basic level where a user can select from a pre-configured menu of avatars of varying types, physical characteristics, and voices.

The second level of complexity may be an intermediate level where a user can upload a picture and the system, using artificial intelligence and machine learning, can animate the image to generate the avatar. The third level of complexity may be an advanced level where the user can approve what the systems suggests. For example, if an input mentions that the user's grandma was a caring and trusted figure in the user's life, then the system can auto-generate an avatar having characteristics similar to the grandma. The user can further customize the generation to their preferences. Conversely, if the input describes the grandma as stern or overbearing, then the virtual assistant application can determine not to generate an avatar that has characteristics resembling the grandma.

Ultimately, through the use artificial intelligence and machine learning, the outputs (e.g., representations) generated by the virtual assistant application can portray an avatar that is emphatic, encouraging, and non-judgmental. The avatar can have characteristics that positively resonate with the user because the avatar may match the style of the user or may be customized by the user to portray someone or something of importance and significance in the user's life. These characteristics of the avatar will result in a virtual assistant application that will be more frequently used and revisited by users thereby increasing user engagement and time spent with the virtual assistant application. As a result, the efficiency, accessibility, and accuracy of the customer service experience will be improved as the avatar learns and discerns more information about the user as it relates to the specific task the user seeks to accomplish. Moreover, the virtual assistant application can closely tailor the output (e.g., representation) to the specific task that the user seeks to accomplish in a way that conforms to the style and intent of the user thereby resulting in more accurate and efficient customer service. This combination of features provides the user with comfort and candidness in interacting with the virtual assistant application.

The following example is intended to provide an overview of the implementation of the virtual assistant application. The example is not intended to limit the present disclosure, but rather is intended as an overview of the present disclosure to provide the reader with an understanding of the numerous benefits and advantages that the techniques described herein provide. The example may utilize the various components and details described herein such as a user device including a display region that has a visualization interface. The example may also utilize a computing device configured to implement a virtual assistant application. The virtual assistant application including the pre-processing module and conversation manager modules discussed above and, in more detail, below.

According to one particular example, the implementation of the virtual assistant application can be conceptualized in three principal steps. First, a user can engage in conversation with the virtual assistant application and the avatar can prompt the user to tell their full “story” (e.g., what does the user seek assistance on). Obtaining a user's full story may be done over multiple sessions. Additionally, and as mentioned above, the avatar can be customized by the user (e.g., pre-selected based on pre-configured avatars or system suggestions) and its appearance can change based on information from prior sessions. To obtain sufficient details from the user to determine their intent, the virtual assistant application prompts the user with open-ended questions. This can include questions such as “tell me more,” “how did you feel when that happened,” or “how did that event affect your attitude toward your financial situation.” This interview style (e.g., open-ended questions) and the responses provided by the user allow the virtual assistant application to better understand the user (e.g., understand their emotional ties or origin story). This allows the virtual assistant to tailor responses in a way that will more likely result in the user taking action due to the increased personalization that the user may feel. Additionally, the virtual assistant application can ask the user to fill in gaps in the story or ask questions that give clues or insights into the user's current situation (e.g., “did you have a job in college and if so, how did you spend what you earned?”).

The next step is for the virtual assistant application to extract the intent of the user and to create a timeline graphic of the journey. Based on the story provided by the user, through the use of pre-configured rules and/or a pre-trained machine learning model, the virtual assistant application establishes an understanding of the user's situation. In one example related to finances, this may include the customer's attitudes about money (e.g., predicted causation between life events, patterns of behavior, and even “black swan” events), the customer's current financial situation, the customer's financial goals, and persons in the customer's life with whom they feel positive and comfortable with (this information may be used to auto-suggest customizations to the avatar). Additionally, the virtual assistant application may review this understanding with the customer (e.g., recite the story back to the customer) and perform updates to the understanding based on the user responses. Together, the virtual assistant application and the user refine the virtual assistant application's understanding until the user is satisfied.

Staying with the financial example, after the virtual assistant application establishes an understanding of the user's situation, a timeline graphic may be generated to show the user's financial journey. The timeline can visually illustrate the various sources that led to the user's current situation (e.g., significant milestones like finishing school or getting licensed, a history of income levels, or a history of expenditures, snapshots of what the current situation is corresponding to current assets and liabilities, future milestones such as retirement, and whether the current trajectory means that the story has a likelihood of coming true).

The virtual assistant application can also suggest a set of actions that the user can implement to improve the trajectory (e.g., satisfy the intent). The user and virtual assistant application can refine the set of actions based on updates or new inputs. Thus, over time, the virtual assistant application can be an ever-improving advice-giver and execution helper to make the future story (e.g., desired results) come true. Additionally, the set of actions may be displayed to the user in a “story” format (e.g., anecdotally) from the second- or third-person perspective. The inventors have determined that using third-person perspective may help the user see themselves in a more objective light. As such, in some examples, the virtual assistant application may provide a representation of the set of actions as it relates to other users or people to provide users with a differing perspective as it relates to their own situation.

The virtual assistant application may utilize additional techniques in the representation to more effectively assist the user. One technique can include spreading out the set of actions over time to keep the momentum. Another technique can include utilizing is reframing (e.g., a difficult task can be framed as something that helps the user's family). Yet another technique can include encouraging the user by reminding them of their past to demonstrate that they've been able to overcome obstacles previously. Yet another technique, which may be helpful for long-term goals, can include celebrating achievements (e.g., twice a year, the system can show that the user's extra payments on their mortgage have shortened their payback period by an amount of months).

The following is an example story implementing the key principles discussed above. Consider the following hypothetical conversation between a user and the virtual assistant application:

| | | |
|---|---|---|
| User Input | → | We didn't have much growing up, and it |
| | | pained me to see my mother sacrificing so |
| | | much just to be able to put money in an |
| | | envelope. |
| Virtual Assistant | → | What was she saving the money for? |
| Response | | |
| User Input | → | She would save up buy me nice clothes so I |
| | | wouldn't be embarrassed at school. |
| | | Whenever my uncle would give me money |
| | | as a gift, I would give some to mom and |
| | | save the rest, until I was eventually able to |
| | | afford vocational school. |
| Virtual Assistant | → | That's very impressive that you were able to save |
| Response | | for vocational school. Do you keep that savings |
| | | habit now? And if so, what do you save for now? |
| User Input | → | Now that I'm all grown up and live |
| | | comfortably, I put some money in savings, |
| | | but I always make sure to dress in high-end |
| | | clothes. Oh, and I never say no when |
| | | someone asks me for money or if I get mail |
| | | asking for charitable donations - I guess I'm |
| | | generous because I know what it's like to be |
| | | hard up. |
| Virtual Assistant | → | Do you worry about the future? |
| Response | | |
| User Input | → | I worry though about how to support myself |
| | | when I grow old. I take care of my mom |
| | | now, but in 20 years, who will take care of |
| | | me? |

Based on the above sample dialogue, the virtual assistant application may establish the user's attitudes about money including: scarcity, fear of lack of money, fear of looking poor (willingness to spend money for visual image), discipline in saving for aspirations (behavior modeled from parent), cognizance of the value of investments (because historically saved up to invest in education), altruism in giving money, financially supportive of parents, or a fear of scare financial situation in retirement. The virtual assistant application may also establish the user's current financial situation including that the user is not in need of money and has disposable income, the user is putting money in savings, the user is financially supporting a parent, and that the user donates money. In response to this established understanding, the virtual assistant application can generate outputs to the user (e.g., a representation) about what factors have led up to the current situation (e.g., significant milestones including finishing vocational school and getting licensed, a history of income/salary levels, history of expenditure totals per category, a snapshot of the current situation including assets and liabilities as of today). In generating the outputs, the representations can also include a future trajectory for the user and a set of actions the user can take to improve the trajectory (e.g., satisfy the intent). The set of actions may also be displayed to the user in a “story” format (e.g., anecdotally) from the second- or third-person perspective to assist the user in seeing themselves in a more objective light as compared to other users or people thereby providing a differing perspective for the user as it relates to their own situation.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods for a virtual assistant application using machine learning are provided below in relation to the drawings.

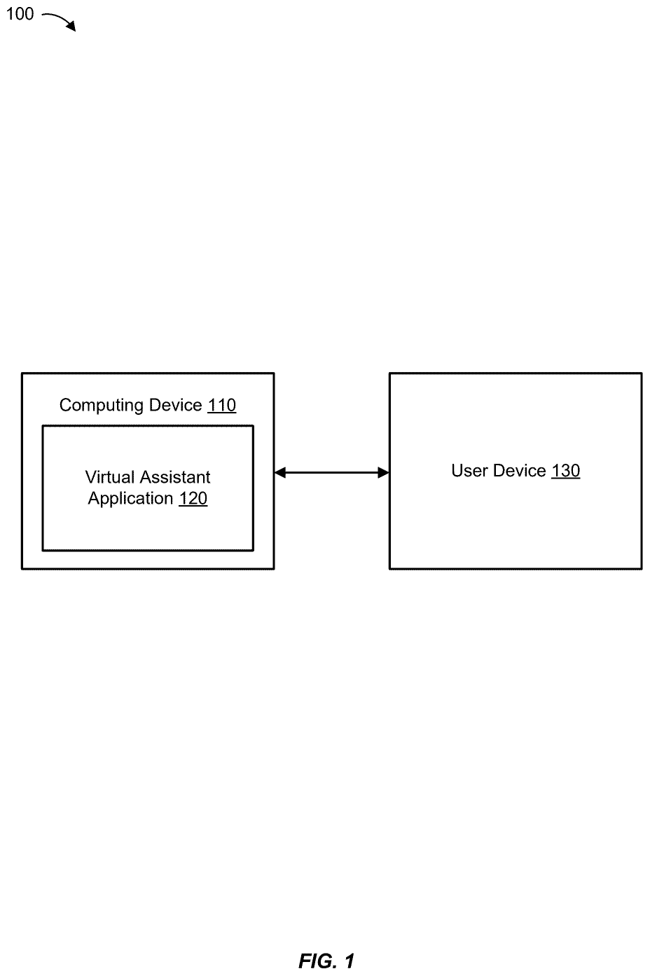

FIG. 1 is a block diagram illustrating an example virtual assistant application environment 100, according to some aspects of the present disclosure. Virtual assistant application environment 100 includes computing device 110 and user device 130. In the example illustrated in FIG. 1, computing device 110 includes virtual assistant application 120 that a user of the user device 130 can engage with in the form of a conversation using the techniques described herein. Examples of a user device 130 can include any type of mobile electronic device such as a mobile phone, a smart phone, a desktop computer, a laptop computer, a smart watch, and the like. User device 130 can include other types of electronics such as a camera, microphone, speaker, and the like to allow a user to engage with virtual assistant application 120.

Computing device 110 can process data received from user device 130. In some examples, the data received from the user device 130 can be in the form of a question or query of a user who is seeking advice or assistance from the virtual assistant application. In other examples, the data received from the user device 130 can be in the form of a formal or informal conversation that a user of the user device 130 is having with the computing device 110. For the sake of simplicity, the data received at the computing device 110 as discussed herein is referred to as “inputs,” however one of ordinary skill will appreciate that inputs could refer to questions, answers, or any other form of natural language dialogue of humans.

In some examples, the inputs can include text data, such as a text data that is manually typed into the user device 130 by a user and received by computing device 110. In some examples, the text data received by the computing device 110 can be from a dialogue window that is displayed on user device 130 and prompts a user to type into it using a keyboard. Computing device 110 can also process text data that is received from a text file, such as a word processing document, uploaded to the user device 130 and transferred, via any means of electronic transfer, to computing device 110. When computing device 110 receives text data via a text file, computing device may have additional functionality of scanning the text file through optical character recognition to process the document and to extract the information contained within the text file for analysis by the virtual assistant application.

In other examples, the inputs received from computing device 110 can include audio data. Audio data can be spoken utterance by a user of the user device 130 that is processed by the computing device 110 for use by virtual assistant application 120. In some examples, computing device 110 may use a speech-to-text algorithm (not shown) to convert the audio data into text data for processing by computing device 110. Additionally, or alternatively, the inputs received by computing device 110 could be video data captured from a camera. In some examples, the data received by the computing device 110 could be any combinations of text data, audio data, or video data.

After computing device 110 processes the inputs received from user device 130, virtual assistant application 120 of computing device 110 can generate outputs. One type of output generated by computing device 110 is a graphical visualization component. The graphical visualization component is discussed in more detail below, but in general, the graphical visualization component can depict a timeline, graph, and the like to assist a user of the user device 130 in response to the input. The computing device 110 can also generate text outputs in the form of a dialogue. These text outputs can be associated with a set of actions that a user can take based on the input.

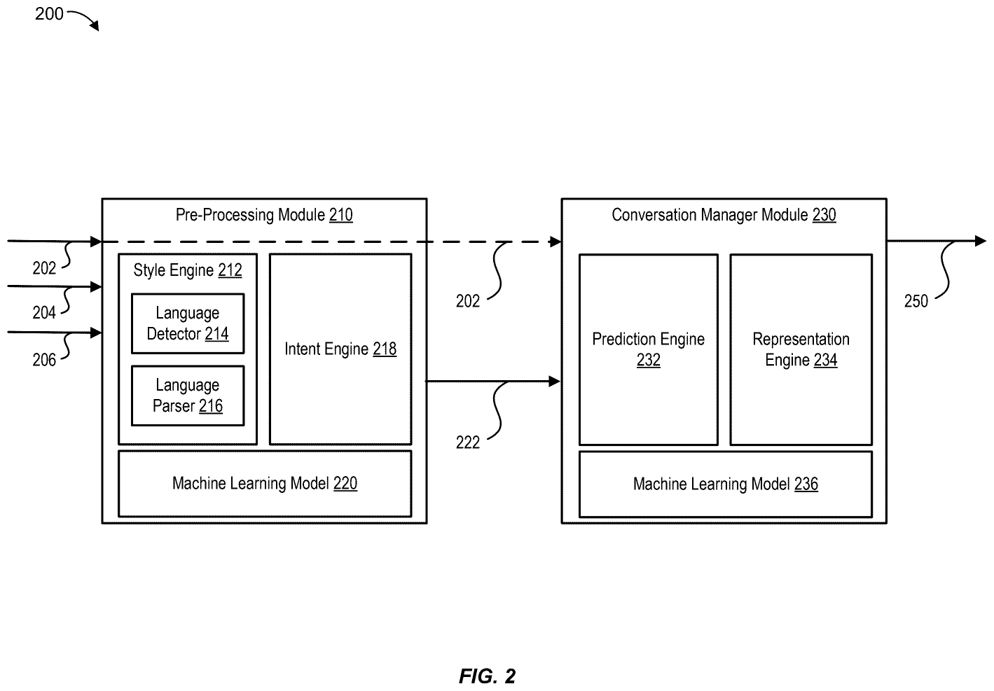

FIG. 2 is a block diagram illustrating a computing system 200 implementing a virtual assistant application (e.g., virtual assistant application 120), according to some aspects of the present disclosure. Computing system 200 includes a pre-processing module 210. Pre-processing module 210 can be configured to receive, as input, text input 202, audio input 204, or video input 206. In some examples, pre-processing module 210 can receive any combination of text input 202, audio input 204, or video input 206. The term “input” as used herein can refer to any form of input data such as text input, audio input, or video input. The term “input” is utilized for the purposes of simplicity, but it will be appreciated that the computing systems as described herein can receive any type of data as input. Additionally, the described inputs received by the computing systems can be generated by a user of the computing systems or received from another computing system.

Once received by computing system 200, pre-processing module 210 performs operations on the inputs. These operations can be referred to as pre-processing operations. After computing system 200 has completed pre-processing on the inputs, computing system 200 generates extracted data 222. In some examples, an input to computing system 200 may bypass pre-processing module 210 and be sent directly to conversation manager module 230, discussed in more detail below. In these examples, the input received by pre-processing module 210 may be of such a nature that pre-processing is not required, such as if the input received is a “yes/no” input. However, in other examples, such as the case when the inputs are longer in length or of a higher complexity, pre-processing by the pre-processing module 210 may be required.

To perform the pre-processing operations on the inputs, pre-processing module 210 includes style engine 212. Style engine 212 can be configured to determine a style of the inputs based on one or more characteristics of the input. For example, style engine 212 can determine that inputs are informal in tone and mannerisms the input includes the use of colloquial terminology. Additionally, style engine 212 can discern that the inputs comprise a loose sentence structure. As a result, style engine 212 can flag the inputs with an appropriate characterization (e.g., “casual” or “informal”). The determined style can be included in extracted data 222 and when conversation manager module provides outputs via the representation engine 234, the output can be tailored to match the determined style.

Style engine 212 may include additional sub-systems that provide additional features or functionality. As illustrated in FIG. 2, style engine 212 may include language detector 214. Language detector 214 can be configured to detect the language associated with the input received. The detected language can be included in the extracted data 222 that is passed to the conversation manager module 230. In some examples, and although not illustrated in FIG. 2, language detector 214 can be configured convert audio input 204 or video input into text data via a speech-to-text or video-to-text algorithm. Also included in style engine 212 is language parser 216. Language parser 216 may perform some or all of the operations discussed above in reference to the style engine 212. For example, language parser 216 can analyze the sentence structure and vocabulary of the inputs to determine a style.

Also included in pre-processing module 210 is intent engine 218. Intent engine 218 may work in conjunction with style engine 212 to perform pre-processing operations on the inputs received by the computing system 200. Intent engine can be configured to analyze the inputs to determine an intent. As used herein, the determined intent of the input corresponds to a problem to be solved. In an example, a user interacting with computing system 200 may provide an input to the system as “I want to buy a home, but I don't have enough money.” In response to this input, the intent engine 218 can analyze the input and determine that the intent of the user is to buy a home and the problem to be solved is to provide direction as to how the user can save an appropriate amount of money to afford a home. In other words, the intent engine can determine the problem to be solved by the user including the reasons that the user is seeking advice or help. This determination can be included in the extracted data 222 that is passed to the conversation manager module 230.

Pre-processing module 210 may also include machine learning model 220. In some examples, machine learning model 220 may be a large language model. Machine learning model 220 may be used by pre-processing module 210 to evaluate the inputs received by computing system 200. Machine learning model 220 can be trained using a large corpus of text data and can be tailored to the specific tasks required by the style engine (e.g., determining a style of the input based on characteristics of the inputs) or the intent engine (e.g., parsing the inputs to determine the problem to be solved).

As mentioned above, once pre-processing operations are performed on the inputs, the determined style and intent are stored in extracted data 222 and passed to conversation manager module 230. Similar to pre-processing module 210, conversation manager module 230 may include sub-systems for added features and functionality. Conversation manager module 230 may include prediction engine 232, representation engine 234, and machine learning model 236. Although FIG. 2 is illustrated with two separate machine learning models (e.g., machine learning model 220 and machine learning model 236), it will be appreciated that a single machine learning model may be used to perform the operations described herein. Conversation manager module 230 can be communicatively coupled to the pre-processing module 210 and can receive extracted data 222 from pre-processing module 210 or an original input, such as text input 202, that has not undergone the pre-processing operations described above. Extracted data 222 can include the original text data processed by pre-processing module 210, and it can also include additional information about the one or more inputs including information about the style, as determined by style engine 212, or information about the intent (e.g., the problem to be solved) as determined by the intent engine 218.

Included in conversation manager module 230 is prediction engine 232.

Prediction engine 232 can receive the extracted data 222 and perform further processing on it. For example, prediction engine 232 analyze the extract data 222 and predict a set of actions to be taken that will satisfy the intent (e.g., problem to be solved). In some examples, the set of actions to be taken can be generated by machine learning model 236. Similar to machine learning model 220, machine learning model 236 can be a large language model trained on a large corpus of text data for the specific task of generating the set of actions to be taken to satisfy the intent.

Representation engine 234 is also included in conversation manager module 230. Representation engine 234 can be configured to generate a representation 250 of the set of actions generated by the prediction engine 232. In some examples, representation 250 can include a text display of the set of actions generated by the prediction engine 232. In other examples, the representation 250 can include a graphical visualization component, such as a timeline, where each element in the timeline corresponds to a timeframe and specific action that the user can take to satisfy the intent (e.g., the problem to be solved). Other graphical visualization components are possible as well such as an animated cartoon acting out the set of actions, a graph illustrating a projected outcome over time, and the like. Additionally, representation engine 234 and prediction engine 232 can generate the set of actions and representations taking into consideration the determined style and intent of the one or more inputs. In this way, the representation generated by the computing system 200 can match the style or intent of the inputs.

Computing system 200 can also include additional features and functionality not shown. For example, computing system 200 can include a data store that can include the rules and training data used by the pre-processing module 210 or the conversation manager module 230. The data store can be communicatively coupled to the pre-processing module 210 or the conversation manager module 230 such that each of the sub-systems access to the data stored in data store. As an example, the data store may be configured to store rules that can be implemented by pre-processing module 210 to determine the style or intent of the inputs. This may include rules for determining the style or intent based on the determined language as determined by the language detector 214 or rules for determining the style or intent based on the sentence structure or vocabulary implemented by language parser 216 on the text input 202, audio input 204, or video input 206.

The data store can also include training data used to train machine learning model 220 or machine learning model 236. Training data is required to train machine learning models. The training data can include a large corpus of previous inputs received by computing system 200 such as a large corpus of text data, audio data, or video data received from many different users. The training data also can be updated as the computing system 200 receives new inputs (e.g., from users interacting with the computing system 200) such that computing system 200 is constantly updating the training data with new data to thereby improve the performance and accuracy of machine learning model 220 or machine learning model 236. Additionally, training data can enable the algorithms of machine learning model 220 or machine learning model 236 to understand and learning certain patterns or features of text input 202, audio input 204, or video input 206 such that machine learning model 220 can determine a style or an intent and generate a representation in an accurate and efficient manner.

The use of machine learning models in the computing system 200 of FIG. 2 provides numerous benefits and advantages as compared to conventional techniques. For example, the virtual assistant application described in conjunction with FIG. 1 and FIG. 2 may utilize artificial intelligence and machine learning to discern more information about the user as it relates to the specific task the user seeks to accomplish. In this way, the virtual assistant application can closely tailor its recommendations to the specific task that the user seeks to accomplish thereby resulting in more accurate and efficient customer service. Additionally, the described virtual assistant application can learn over time based on previous interactions with users in an automatic and efficient manner to improve its responses and accuracy. This reduces the need for manual training, updates, monitoring, or human intervention of the customer service experience. This also increases computational efficiency, accessibility (e.g., a virtual assistant application can be widely deployed over the internet and accessible at any time), and understanding of complex problems.

The use of artificial intelligence and machine learning the virtual assistant application also improves the efficiencies of a device on which the virtual assistant application is located (e.g., a computer, mobile phone, or other computing device) since the application is updated (e.g., learns) and is retained on an on-going basis; thus, the responses generated by the virtual assistant application are not stale or pre-programmed, but rather are dynamic and automatically updated based on learned events. This leads to an increase in the likelihood that users will interact with the virtual assistant application, rather than another source of information (e.g., searching terms and explanations on the internet).

Moreover, numerous benefits are achieved by way of matching the representation 250 to the style and intent of the inputs. For example, the inventors have determined that a user interacting with computing system 200 will feel more comfortable when the representations match their inputs. This can lead to the user being more honest with the computing system, which in turn, allows the computing system 200 to provide representations that are narrowly tailored to the user's specific problem to be solved. Additionally, when the representations match the style and intent of the user, the user may interact with the virtual assistant application more frequently and for longer periods of time because the user may feel more of a connection to the virtual assistant application and the user may feel that the virtual assistant application genuinely wants to help the user accomplish their goals. These benefits lead to increased efficiencies in computing systems by saving resources because the virtual assistant application can be the “one stop solution” for any issue that a user may face. Thus, rather than the user searching on the web for answers to their problems and questions, the user can consult with the virtual assistant application to get the answers they need.

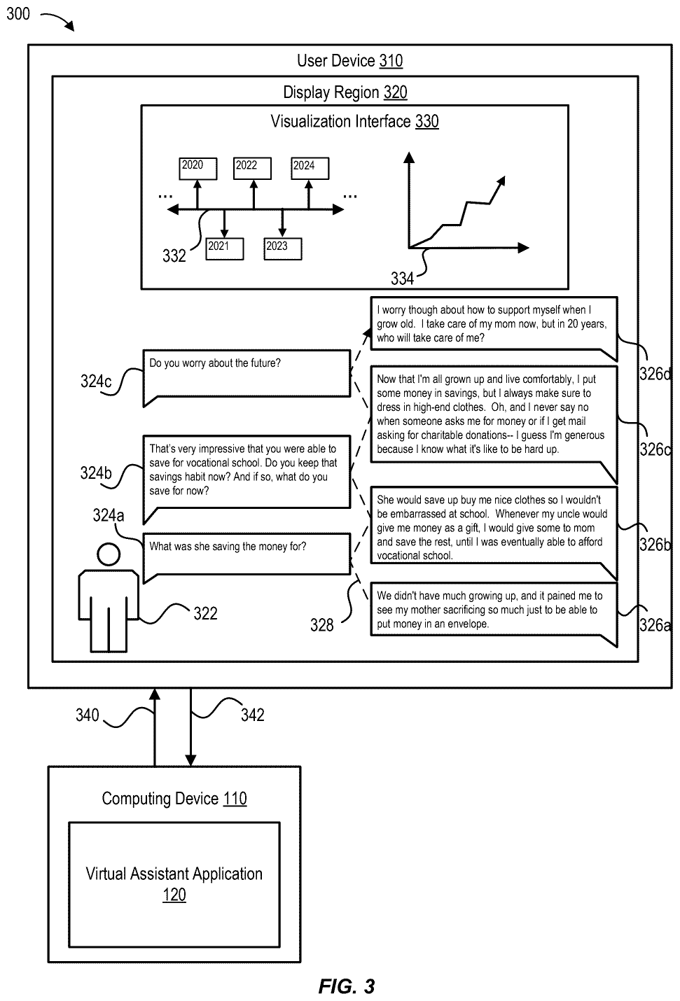

FIG. 3 is a block diagram illustrating an example virtual assistant application environment 300, according to some aspects of the present disclosure. Computing device 110 can be configured to implement a virtual assistant application 120. This can include the operations described in connection to virtual assistant application environment 100 as illustrated by FIG. 1 and computing system 200 illustrated by FIG. 2.

As illustrated in FIG. 3, virtual assistant application environment 300 includes computing device 110 and user device 310. Computing device 110 includes virtual assistant application 120. As further illustrated in FIG. 3, computing device 110 is communicatively coupled to user device 310. Computing device 110 can be communicatively coupled to user device 310 via a wired or wireless connection (e.g., over a network). Additionally, computing device 110 can generate representation 340 for display on user device 310. Representation 340 can include the graphical and or non-graphical representations discussed in relation to representation 250 discussed of FIG. 2. Additionally, computing device 110 can receive responses (e.g., inputs) 342 from user device 310. Input 342 can correspond to an input received by a user of the user device 310 (e.g., any one of the text input 202, audio input 204, or video input 206 discussed in relation to FIG. 2). In this way, user device 310 is able to communicate with computing device 110 to engage with virtual assistant application 120.

Also included in user device 310 is display region 320 for displaying information to the user. This information can include information contained in the representation 340 generated by computing device 110. Display region 320 of user device 310 can be a screen such as a television screen, phone screen, computer screen, or external monitor configured to display the received information to a user. To facilitate these functions, display region 320 may include visualization interface 330. Visualization interface 330 can be configured to display graphical visualization components generated by virtual assistant application 120. By way of example, and as illustrated in FIG. 3, the graphical visualization component can include timeline 332 or graph 334. These graphical visualization components are discussed in more detail above in relation to FIG. 2, but in essence, the graphical visualization components can provide information to a user to help the user satisfy their intent (e.g., the problem to be solved).

Also included in display region 320 is avatar 322. Avatar 322 can communicate with a user of the user device 310. Avatar 322 can communicate, in the form of a conversation, with a user of the virtual assistant application environment 300. As illustrated by FIG. 3, this can include a sequence of dialogue boxes. User dialogue boxes 326a-326d can correspond to natural language inputs of the user of the user device 310. As previously described, this can include text, audio, or video inputs. In the case of audio or video inputs, a speech-to-text algorithm can convert the input into text data for display on user device 310 and/or analysis on computing device 110. Avatar dialogue boxes 324a-324c can correspond to the outputs generated by the conversation manager module of the virtual assistant application 120. As illustrated in FIG. 3, the avatar 322 can engage in an open-ended conversation with a user of the user device 310. The avatar can prompt the user with follow up questions and tailor its responses to the style and intent of the user all the while processing the information to generate a representation (e.g., graphical or non-graphical representation) of a set of steps the user can take to satisfy the problem to be solved. This is illustrated in FIG. 3 with an example dialogue exchange 328. Although not illustrated in FIG. 3 for the sake of, avatar 322 can be customizable to appear in any manner that the user desires.

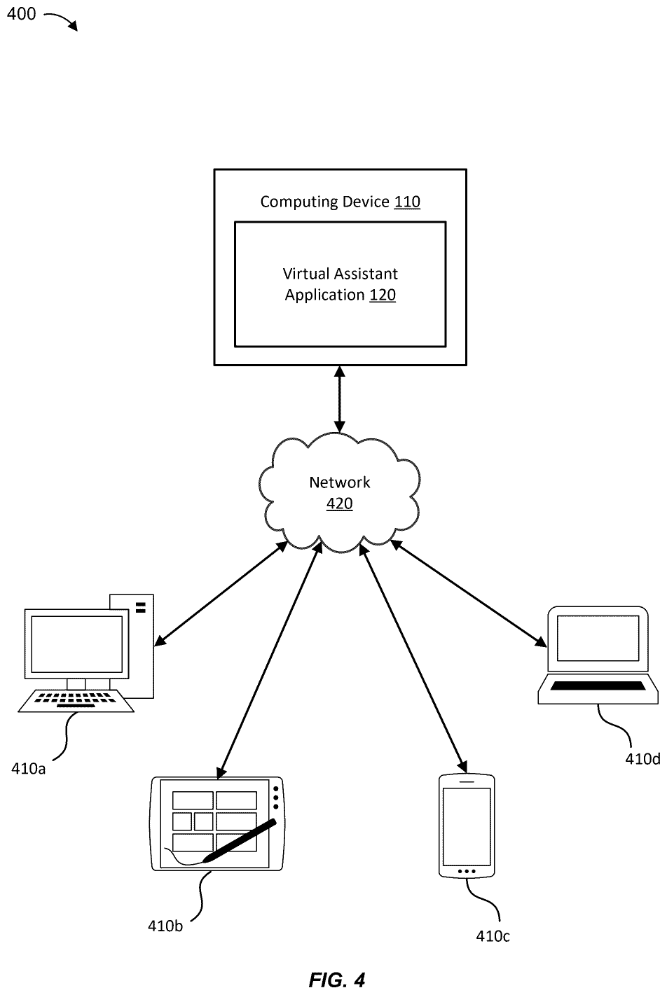

FIG. 4 is a block diagram illustrating a distributed system 400 for implementing a virtual assistant application, according to some aspects of the present disclosure. As illustrated in FIG. 4, distributed system 400 includes one or more user devices 410a-410d, which are configured to execute and operate virtual assistant application 120 over at least one network 420. As discussed herein, user devices 410a-410d may be desktop computing systems, such as desktop computer 410a, or other forms of portable electronic devices such as tablet 410b, smartphone 410c, or laptop 410d. User devices 410a-410d may run software to allows for communications over network 420 to allow user devices 410a-410d to engage and interact with computing device 110 and virtual assistant application 120. While distributed system 400 is illustrated with four example user devices 410a-410d, any number of user devices are possible. Additionally, any number of alternative devices such as smart watches, cameras, microphones, and the like are possible.

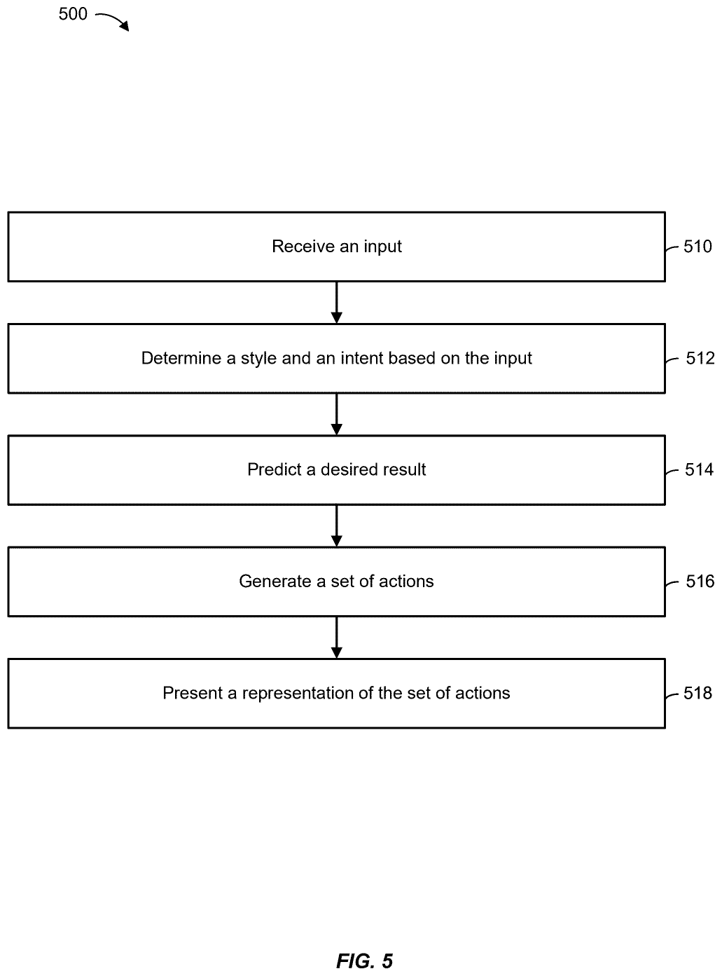

FIG. 5 is a flowchart of an example of a process 500 for implementing a virtual assistant application, according to some aspects of the present disclosure. In some embodiments, some of the steps in flowcharts of FIG. 5 are implemented in program code executed by a processor, for example, the processor in a general-purpose computer, mobile device, or server. In some examples, these steps are implemented by a group of processors. In some examples, the steps shown in FIG. 5 are performed in a different order or one or more steps may be skipped. Alternatively, in some examples, additional steps not shown in FIG. 5 may be performed.

As shown in FIG. 5, the process 500 begins at step 510 when a processor receives an input. In one embodiment, the input can be associated with a problem to be solved. The input can be received by the processor via a user device as discussed herein and may be in the form of natural language text data, audio data, or video data. Additionally, in the case of audio or video data, the processor may have additional functionality, such as a speech to text algorithm, that is configured to convert the speech or video data into text data for processing. Further, as discussed herein the problem to be solved can correspond to a financial goal that a user of the process seeks to accomplish.

Next, at step 512, a processor analyzes the input to determine a style and an intent based on the input. As discussed previously, the style can be associated with one or more characteristics of the input and can be determined based on the sentence structure or the vocabulary used, for example. The intent can be associated with a problem to be solved. In other words, a question or goal that the user has in mind and is looking for guidance on how to achieve it. In some examples, the style and the intent of the input can be determined by a machine learning model. After determining the style and the intent, the processor can generate extracted data that includes information about the style and the intent as well as information about the original input (e.g., the original text, audio, or video input).

Then at step 514, the processor predicts a desired result based on the extracted data associated with the style and intent of the input. The predicted result can be associated with the intent such that the predicted result corresponds to a goal that the user seeks to accomplish. At step 516, the processor generates a set of actions. The set of actions can correspond to a bite-sized actions that the user of the process can follow to accomplish the predicted result corresponding to the input.

Then at step 518, the processor presents a representation of the set of actions. In some examples, the representation of the set of actions can include a graphical visualization component such as an animated cartoon, a timeline, or a graph. In other examples, the representation can be a non-graphical representation in the form of a text output displayed on a user device for viewing by a user. In some examples, the representation can be presented in the form of a conversation the user and an avatar, where the representation is a sequence of dialogue boxes that are presented on a display for viewing by the user. Additionally, the representation of the set of actions can match the determined style and intent of the input. In other words, the representation can correspond to the style and the intent of the user by using similar tone, vocabulary, formalities, and sentence structure. Moreover, the representation can be presented to the user in “story” format (e.g., anecdotally). In some examples, the story may be presented to the user from the first-, second-, or third-person perspective. The inventors have determined that using third-person perspective may help the user see themselves in a more objective light. As such, the representation of the set of actions presented in story format provides the user with a differing perspective on their own situation as it relates to other users or people.

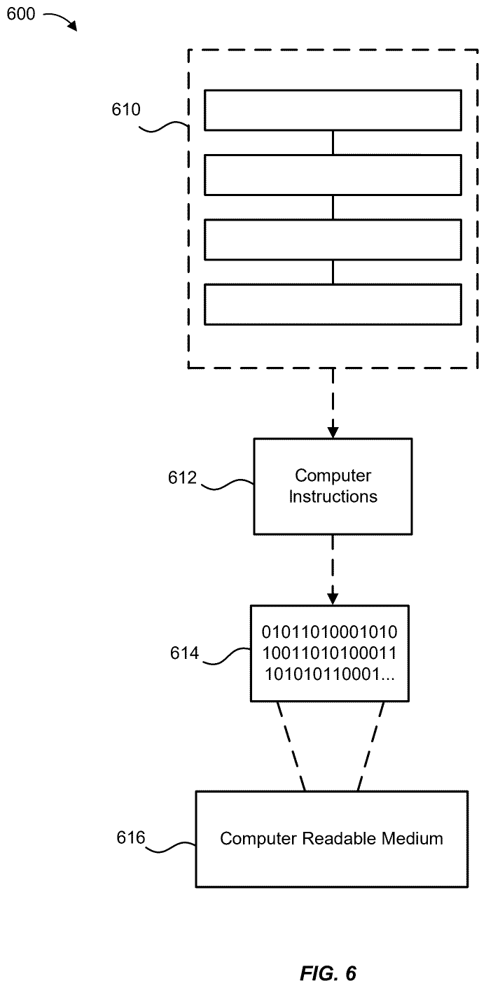

One or more of the aspects of the present disclosure include a computer-readable medium including microprocessor or processor-executable instructions configured to implement one or more embodiments presented herein. As discussed herein the various aspects provide systems and methods for implementing a virtual assistant application using machine learning. FIG. 6 is a block diagram illustrating an example computer-readable medium or computer-readable device including processor-executable instructions configured to embody one or more of the aspects set forth herein. As illustrated in FIG. 6, implementation 600 a computer-readable medium 616 is provided. Computer-readable medium can include a CD-R, DVD-R, flash drive, a platter of a hard disk drive, and so forth, on which computer-readable data 614 is encoded and stored. The computer-readable data 614, such as binary data including a plurality of zero's and one's as illustrated, in turn includes a set of computer instructions 612 configured to operate according to one or more of the principles set forth herein.

In the illustrated implementation 600 of FIG. 6, the set of computer instructions 612 (e.g., processor-executable computer instructions) may be configured to perform a method 610, such as the process 500 of FIG. 5, for example. In another embodiment, the set of computer instructions 612 may be configured to implement a system, such as the virtual assistant application environment 100 of FIG. 1, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

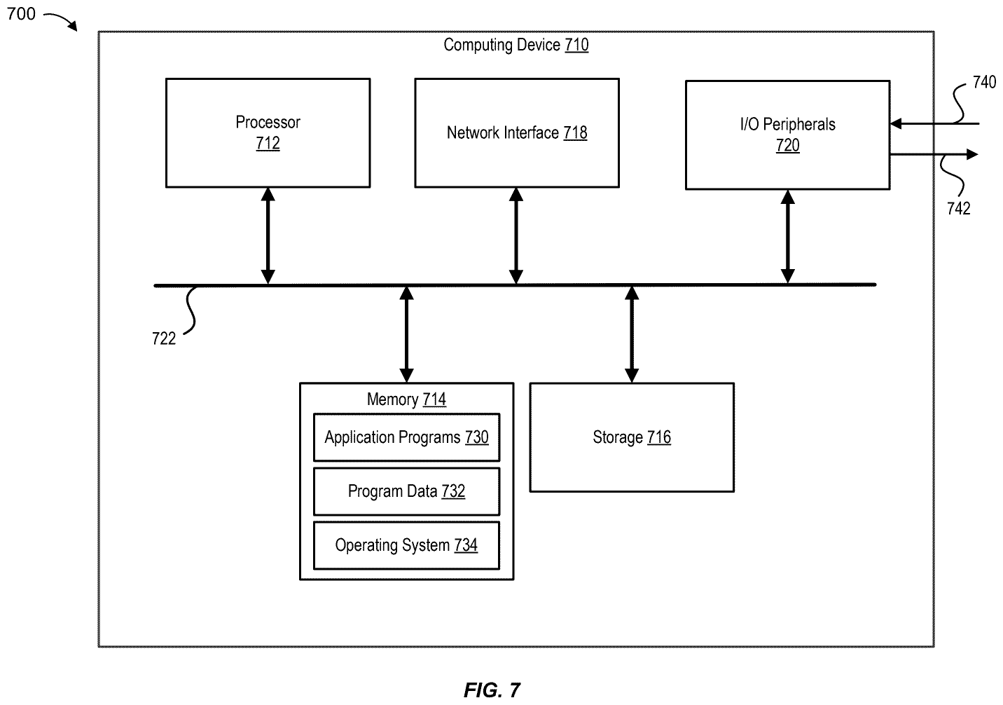

FIG. 7 and the following discussion provide a description of a suitable computing environment 700 to implement embodiments of one or more of the aspects set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 7 is a block diagram illustrating an example computing environment 700 for implementing a virtual assistant application using machine learning, according to some aspects of the present disclosure. In one configuration, the computing device 710 may include at least one processor 712 and at least one memory 714. Depending on the exact configuration and type of computing device, the at least one memory 714 may be volatile, such as RAM, non-volatile, such as ROM, flash memory, etc., or a combination thereof. Examples of processor 712 include a microprocessor, an application-specific integrated circuit (ASIC), a field-programmable gate array (FPGA), or any other suitable processing device. Computing device 710 can include one processor, such as is illustrated by processor 712 in FIG. 7, or more than one processor.

Computing device 710 may include additional features or functionality. For example, the computing device 710 may include storage such as removable storage or non-removable storage, including, but not limited to, magnetic storage, optical storage, etc. Such storage is illustrated in FIG. 7 by storage 716. In one or more embodiments, computer readable instructions to implement one or more embodiments provided herein are in the storage 716. The storage 716 may store other computer readable instructions to implement an operating system, an application program, etc. Computer readable instructions may be loaded in the at least one memory 714 for execution by the at least one processor 712, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 7, the computing environment 700 may also include a number of additional external or internal devices, for example, input or output devices. For example, computing device 710 is illustrated as including input/output (I/O) peripherals 720. I/O peripherals 720 can receive input 740 from an input device (not shown) or provide output 742 to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 710. I/O peripherals 720 may be connected to the computing device 710 via a wired connection, wireless connection, or any combination thereof. Further, the computing device 710 may include network interface 718 to facilitate communications with one or more other devices (not shown). Network interface 718 can include any device or group of devices suitable for establishing a wired or wireless data connection to one or more data networks. Non-limiting examples of the network interface 718 include an Ethernet network adaptor, a wireless network adapter, a modem, Wi-Fi adapter, Bluetooth adapter, NFC receiver and transmitter, and any other known wired or wireless data transmission system.

Interface bus 722 is also included in computing device 710. Although only one interface bus is illustrated, computing environment 700 can include more than one interface bus. Interface bus 722 can communicatively couple one or more components of computing device 710.

Staying with FIG. 7, computing environment 700 includes one or more application programs 730 and/or program data 732 that may be accessible in memory 714 by the computing device 710. According to some implementations, the application program 730 and/or program data 732 are included, at least in part, in the computing device 710. The application programs 730 may include a virtual assistant application program, such as virtual assistant application 120, that is arranged to perform the functions as described herein including those described with respect to the virtual assistant application environment 100 of FIG. 1, computing system 200 of FIG. 2, virtual assistant application environment 300 of FIG. 3, the distributed system 400 of FIG. 4, and/or the process 500 of FIG. 5. The program data 732 may include virtual assistant application commands and/or virtual assistant application information that may be useful for operation with the various aspects as described herein. Memory 714 also includes instructions for implementing an operating system 734 of computing device 710.

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs.

Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A system for implementing a virtual assistant application using machine-learning, the system comprising:
one or more processors;
a memory coupled to the one or more processors, the memory including instructions that, when executed by the one or more processors, cause the one or more processors to:
receive an input from a user, wherein the input is associated with a problem to be solved;
using a machine learning model:
determine a style and an intent of the user based on the input;
determine extracted data that includes information corresponding to the style and the intent of the user;
predict a desired result based on the extracted data; and
generate a set of actions, based in part on the style of the user and the intent of the user, wherein each action of the set of actions corresponds to a step that the user can take to accomplish the desired result; and
output a signal associated with a representation of the set of actions.

2. The system of claim 1 wherein the problem to be solved corresponds to a financial goal.

3. The system of claim 1 wherein the input is audio input and the instructions further cause the one or more processors to detect a natural language corresponding to the audio input and convert the audio input into text data via a speech to text algorithm.

4. The system of claim 3 wherein the style is determined by one or more vocal characteristics of the audio input.

5. The system of claim 1 wherein the representation of the set of actions includes a graphical visualization component that dynamically updates based on at least one of the input, the intent, or the style.

6. The system of claim 1 wherein the representation of the set of actions includes an audio output.

7. The system of claim 1 wherein the instructions further cause the one or more processors to:
receive a second input from the user; and
adjust, using the machine learning model, the representation of the set of actions based on the second input.

8. A method for implementing a virtual assistant application using machine-learning, the method comprising:
receiving an input from a user, wherein the input is associated with a problem to be solved;
using a machine learning model:
determining a style and an intent of the user based on the input;
determining extracted data that includes information corresponding to the style and the intent of the user;
predicting a desired result based on the extracted data; and
generating a set of actions, based in part on the style of the user and the intent of the user, wherein each action of the set of actions corresponds to a step that the user can take to accomplish the desired result; and
outputting a signal associated with a representation of the set of actions.

9. The method of claim 8 wherein the problem to be solved corresponds to a financial goal.

10. The method of claim 8 wherein the input is audio input and the method further comprises detecting a natural language corresponding to the audio input and converting the audio input into text data via a speech to text algorithm.

11. The method of claim 10 wherein the style is determined by one or more vocal characteristics of the audio input.

12. The method of claim 8 wherein the representation of the set of actions includes a graphical visualization component that dynamically updates based on at least one of the input, the intent, or the style.

13. The method of claim 8 wherein the representation of the set of actions includes an audio output.

14. The method of claim 8 further comprising:
receiving a second input from the user; and
adjusting, using the machine learning model, the representation of the set of actions based on the second input.

15. A non-transitory computer-readable medium embodying program code that, when executed by one or more processors, causes the one or more processors to perform operations comprising:
receiving an input from a user, wherein the input describes a problem to be solved;
using a machine learning model:
determining a style and an intent of the user based on the input;
determining extracted data that includes information corresponding to the style and the intent of the user;
predicting a desired result based on the extracted data; and
generating a set of actions, based in part on the style of the user and the intent of the user, wherein each action of the set of actions corresponds to a step that the user can take to accomplish the desired result; and
outputting a signal associated with a representation of the set of actions.

16. The non-transitory computer-readable medium of claim 15 wherein the problem to be solved corresponds to a financial goal.

17. The non-transitory computer-readable medium of claim 15 wherein the input is a audio input and the operations further comprise converting the audio input into text data via a speech to text algorithm.

18. The non-transitory computer-readable medium of claim 17 wherein the style is determined by one or more vocal characteristics of the audio input.

19. The non-transitory computer-readable medium of claim 15 wherein the representation of the set of actions includes a graphical visualization component that dynamically updates based on at least one of the input, the intent, or the style.

20. The non-transitory computer-readable medium of claim 15 wherein the operations further comprise:
receiving a second input from the user; and
adjusting, using the machine learning model, the representation of the set of actions based on the second input.
